(19) United States
(12) Patent Application Publication
(10) Pub. No.: US 2026/0230180 A1
(43) Pub. Date: Aug. 6, 2026

(54) Computationally Efficient Network Survivability Assessment

(71) Applicant: Ciena Corporation, Hanover, MD (US)

(72) Inventors: Hamed Pouya, Longueuil (CA); Serge Asselin, Kanata (CA)

(73) Assignee: Ciena Corporation, Hanover, MD (US)

(21) Appl. No.: 19/046,670

(22) Filed: Feb. 6, 2025

(51) Int. Cl. H04B 10/077; G06T 11/20

(52) U.S. Cl. CPC H04B 10/077; G06T 11/26; G06T 2200/24

(57) ABSTRACT

Systems and methods for assessing survivability in a network include receiving a representation of the network comprising a plurality of nodes and links, wherein each link is associated with at least one shared risk link group (SRLG); constructing an undirected graph corresponding to the network, wherein vertices represent the nodes and edges represent the links; applying a Stoer-Wagner min-cut algorithm, extended to account for SRLGs, to identify a minimal set of edges whose simultaneous failure would disconnect at least one node from a remainder of the network, wherein links that share an SRLG are treated as a single potential failure event; and providing the minimal set of edges as critical cuts corresponding to an SRLG-based failure scenario, thereby defining a survivability limit of the network.

### FIELD OF THE DISCLOSURE

The present disclosure relates generally to networking and computing. More particularly, the present disclosure relates to systems and methods for a computationally efficient network survivability assessment.

### BACKGROUND OF THE DISCLOSURE

Communication service providers have been facing various constraints, prompting increased investment in automation and optimization tools that simplify network operations processes and reduce costs. One such process is network planning, which includes designing network topologies and allocating resources. A key consideration in network design is survivability, referring to a network's ability to withstand failures (“cuts”)—such as fiber breaks or node outages—by providing path diversity. Evaluating network survivability typically involves computationally intensive failure simulations. Each failure scenario is modeled, and the resulting recovery response is recorded. Although this approach is feasible for smaller networks, the required simulation times grow significantly for larger networks, particularly when multiple simultaneous failures must be considered (a combinatorial problem). This complexity is further compounded in topology optimization tasks, where survivability must be evaluated in each of the hundreds—or even tens of thousands—of iterations in the optimization process. Consequently, employing existing failure simulation techniques in such scenarios often results in an exceedingly long run time, making conventional methods impractical for large-scale or iterative applications.

### BRIEF SUMMARY OF THE DISCLOSURE

The present disclosure relates to systems and methods for a computationally efficient network survivability assessment. Specifically, this disclosure presents a novel, computationally simpler approach for assessing path diversity and network survivability that is particularly well suited for network optimization tasks. The approach extends the Stoer-Wagner algorithm—commonly used to determine min-cut or max-flow in undirected graphs—to evaluate survivability without having to exhaustively model every possible failure scenario. Critically, it incorporates shared risk link groups (SRLG) to capture real-world dependencies that standard Stoer-Wagner analyses typically omit. By handling SRLGs directly, the approach can be used as a self-contained tool for quick survivability assessments or integrated as an engine within any network optimization framework to guide topology design.

The approach specifically determines the number of concurrent link failures a network can tolerate without causing traffic outages, offering several key advantages over conventional techniques. First, it avoids expensive simulations in which all potential failure scenarios must be independently evaluated. Second, it eliminates the need to compute multiple (K) diverse paths for every node pair. Third, it dispenses with traffic matrices altogether, since it does not attempt to route flows. Fourth, it is the only known approach that can handle SRLGs without exhaustive simulation. Finally, unlike traditional graph-theoretic techniques that merely calculate a single min-cut value, it identifies the specific failure scenarios most critical to network performance.

Beyond providing faster, more efficient survivability evaluations, the proposed technique highlights network vulnerabilities and areas for targeted design improvements. This capability allows network planners to develop robust topologies that remain resilient against unforeseen traffic shifts and guarantee a defined level of survivability for a wide range of traffic profiles. Deployed either as an independent survivability evaluation tool or as a metric within broader optimization algorithms, this approach delivers a powerful way to optimize network design, reduce operational costs, and ensure reliable connectivity.

In various embodiments, the present disclosure includes a method having steps, a computing system configured to implement the steps, and a non-transitory computer-readable medium storing instructions that, when executed, cause one or more processors to implement the steps. The steps are for assessing survivability in a network, and the steps include receiving a representation of the network including a plurality of nodes and links, wherein each link is associated with at least one shared risk link group (SRLG); constructing an undirected graph corresponding to the network, wherein vertices represent the nodes and edges represent the links; applying a Stoer-Wagner min-cut algorithm, extended to account for SRLGs, to identify a minimal set of edges whose simultaneous failure would disconnect at least one node from a remainder of the network, wherein links that share an SRLG are treated as a single potential failure event; and providing the minimal set of edges as critical cuts corresponding to an SRLG-based failure scenario.

Applying the Stoer-Wagner min-cut algorithm can include (i) forming an initial set containing a single vertex; (ii) iteratively adding to the initial set a vertex external to the set that has a highest sum of edge weights connecting it to vertices in the set; (iii) upon labeling all vertices, identifying a pair of vertices in a labeling sequence that define a candidate cut separating one vertex from a rest of the graph; (iv) merging the pair of vertices into a single vertex to produce a residual graph; and (v) repeating steps (iii)-(iv) until only two vertices remain, thereby generating multiple candidate min-cuts for the network. The steps can further include aggregating all edges that share a particular SRLG into a unified failure group prior to executing the min-cut algorithm, such that failure of the SRLG corresponds to failure of all edges in that group. The extended Stoer-Wagner min-cut algorithm operates in polynomial time with respect to a number of nodes and links in the network, providing a computationally efficient alternative to exhaustive failure simulations.

The steps can further include replacing, after identifying a critical minimal cut that splits the network into two or more components, each component with a dummy node, and re-running the extended Stoer-Wagner min-cut algorithm on each resulting residual graph to discover additional SRLG-based cuts within each component. The providing can include a ranked list of critical cuts, each critical cut specifying a set of SRLGs that, if failed concurrently, would isolate a portion of the network from the remainder. The steps can further include using the critical cuts to guide a network optimization process, including link rerouting or capacity expansion to mitigate identified vulnerabilities. The network is analyzed without relying on a traffic matrix, thereby determining survivability independently of specific traffic demands or flow patterns. The steps can further include detecting an SRLG-based failure in an operational version of the network and comparing the failure to the identified minimal set to determine whether a mitigation or rerouting procedure must be triggered in real time.

The method can be used to verify compliance with a predefined survivability requirement, such as guaranteeing no outage under any two SRLG failures. The steps can further include storing the minimal set in a database or repository, thereby enabling repeated or incremental survivability analyses without re-running from scratch. The steps can further include presenting the critical cuts via a user interface, wherein each critical cut is displayed alongside corresponding SRLG identifiers and affected network components. The steps can further include updating weights associated with each edge based on newly discovered risk factors or maintenance records, and re-running the extended Stoer-Wagner min-cut algorithm to obtain revised critical cuts. The steps can further include applying a threshold to filter out minimal cuts above a predetermined size, thereby focusing on high-impact cuts that require fewest SRLG failures. A survivability metric can be computed by identifying a smallest integer k for which the network has a min-cut of size k, indicating that concurrent failures of k SRLGs will disconnect at least one subset of the network from the remainder. The steps can further include providing one or more additional minimal sets of edges as critical cuts corresponding to one or more additional SRLG-based failure scenarios.

### BRIEF DESCRIPTION OF THE DRAWINGS

The present disclosure is detailed through various drawings, where like components or steps are indicated by identical reference numbers for clarity and consistency.

FIGS. 1-3 illustrate network diagrams including an Internet Protocol (IP) topology (FIG. 1), placement of the IP topology on an optical network (FIG. 2), and a survivability analysis illustrating impacts of cuts in the optical network on the IP topology (FIG. 3).

FIGS. 4-12 are graph diagrams of a network of eight nodes, labeled 1-8, with each FIG. being a successive step to illustrate the operating principles of the present disclosure.

FIGS. 13-16 illustrate components 1, 2 from the graph (FIGS. 13-14) and cuts in the components 1, 2 (FIGS. 15-16) to determine critical cut scenario that result in isolated islands.

FIG. 17 illustrates a graph of time to perform the process (labeled “diversity alg.”) relative to a traditional bundle failure analysis (BFA) (both 2-cut and 3-cut).

FIG. 18 illustrates a flowchart of a process for assessing survivability in a network.

FIG. 19 illustrates a block diagram of a computing device that may be used to implement the process of FIG. 18.

### DETAILED DESCRIPTION OF THE DISCLOSURE

Again, the present disclosure relates to systems and methods for a computationally efficient network survivability assessment. Network operators typically rely on a time-consuming process called Failure Simulation to evaluate network survivability against concurrent node or link failures. This method systematically enumerates all potential failure scenarios of a specified size—removing subsets of network elements such as fibers or nodes—and then measures the network's ability to recover and reestablish alternate paths. While comprehensive, exhaustive failure simulation becomes prohibitively expensive for large backbone networks with many possible failures, and it also depends on a specific traffic matrix, meaning survivability is only measured for node pairs that carry traffic.

Other known solutions to survivability challenges include approaches such as computing K+1 diverse paths between A-Z pairs (where “A-Z” denotes two end nodes in a path), which ensures each flow can survive up to K cuts. Mathematical modeling techniques, such as deterministic mixed integer programming (MIP) and Stochastic Optimization, also exist. Deterministic MIP formulations seek the least-cost network configuration capable of routing flows under predefined failure scenarios of size K, whereas Stochastic Optimization techniques rely on sampled failure scenarios to estimate the probability that a flow remains available at least 95% of the time. Stochastic Simulation extends these ideas by repeatedly sampling from a probability distribution of failures to approximate the likelihood that a particular flow survives. Although each of these methods offers valuable insights, they often struggle to balance accuracy, scalability, complexity, memory requirements, and run time. While exhaustive techniques can yield a thorough analysis, they must examine a vast number of scenarios to ensure reliable results, making them both time-intensive and costly.

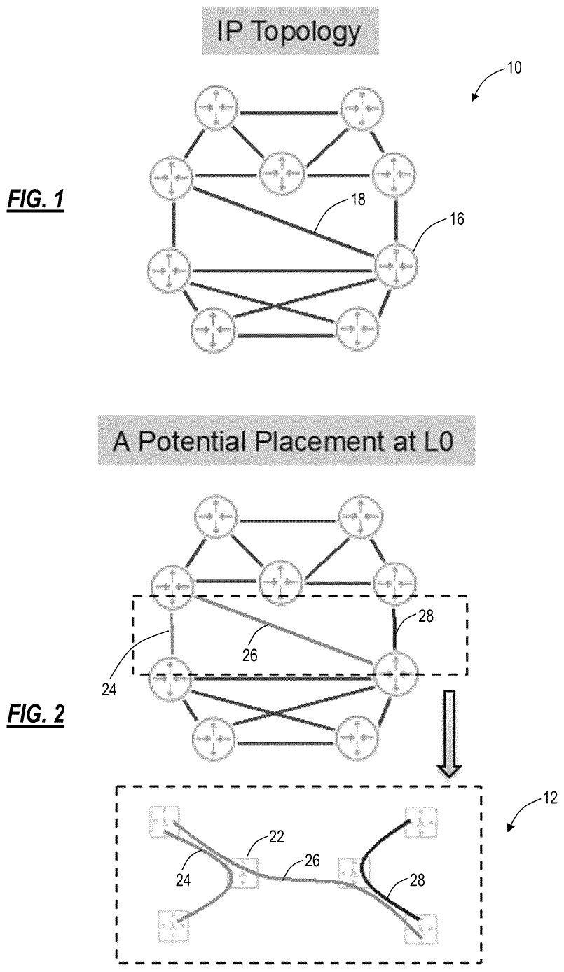

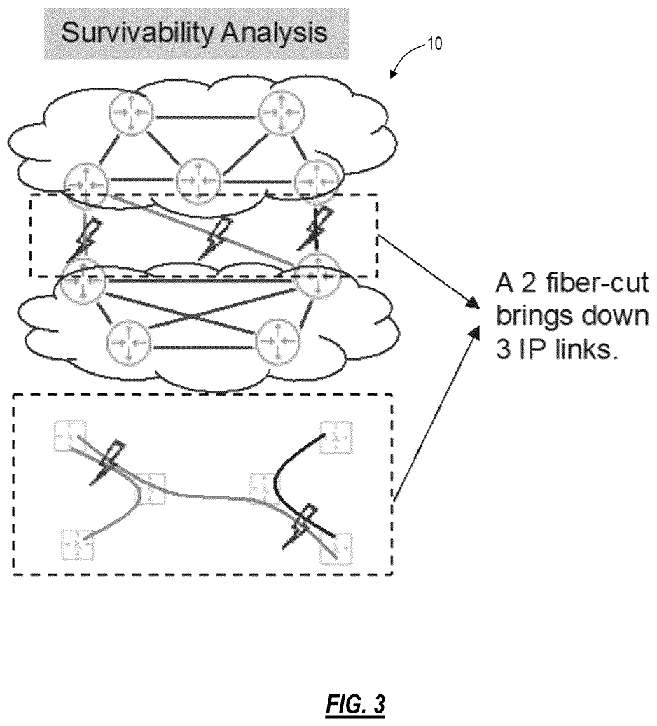

FIGS. 1-3 illustrate network diagrams including an Internet Protocol (IP) topology 10 (FIG. 1), the placement of the IP topology 10 on an optical network 12 (FIG. 2), and a survivability analysis showing how cuts in the optical network 12 affect the IP topology 10 (FIG. 3). In FIG. 1, the IP topology 10 is formed by interconnected routers 16 that establish logical links 18. As shown in FIG. 2, these logical links 24, 26, 28 are physically carried over optical links interconnecting optical network elements 22, such as reconfigurable optical add/drop multiplexers (ROADMs). In this example, the IP topology 10 is initially designed to tolerate a certain number of link failures (e.g., two-link failures, or “2-cuts”) at the IP layer. However, once the IP link 18 is mapped onto the optical link in the underlying photonic network 12, Shared Risk Link Groups (SRLGs) can cause multiple IP link failures to occur simultaneously if even a single double-cut event (or other concurrent failures) happens at the optical layer. Consequently, FIG. 3 illustrates how a double cut at the optical layer may affect multiple IP links 18 at once, thereby undermining the intended survivability of the IP topology 10. This multi-layer interdependency highlights the critical need to account for optical-layer SRLGs when placing IP links at the photonic layer, ensuring that survivability goals are met prior to full-scale network dimensioning or failure simulations. Thus, FIGS. 1-3 provide a clear example of how network survivability hinges on the interaction between IP and optical layers, emphasizing the importance of robust cross-layer planning and analysis.

The IP topology 10—initially engineered to withstand any two-link failures—is shown in FIG. 2, where the logical IP links 24, 26, 28 are physically placed onto an underlying photonic layer (L0) in the optical network 12. Also in FIG. 2, a potential physical placement at L0 is depicted, illustrating how the IP links 24, 26, 28 are routed through the ROADMs at the photonic layer. FIG. 3 underscores the importance of survivability: despite the IP topology 10 being designed for two-link protection (2-cuts), a single double-cut event at the photonic layer can simultaneously bring down three IP links 24, 26, 28, because they share the same physical infrastructure, forming an SRLG. As a result, a topology that appears robust at the IP layer can prove vulnerable once these optical-layer dependencies are taken into account.

Without the proposed technique, verifying whether the topology meets a 2 Cut-No Outage (2 CNO) requirement would involve a comprehensive failure simulation, iterating through various SRLG-induced failure scenarios. This process is both expensive and time-consuming, particularly for large-scale networks. Consequently, a network engineer may discover—after extensive simulation—that the design must be revised regardless, because certain 2-cut situations mapped onto the photonic layer still cause outages. By integrating a methodology that directly incorporates multi-layer SRLG considerations from the outset, network planners can more efficiently identify vulnerable IP link placements and refine the topology before conducting final failure simulations and network dimensioning.

The existence of n+1 link-disjoint paths is both a necessary and sufficient condition for any pair of nodes to remain connected in the face of n simultaneous link failures, ensuring that at least one path always remains available. Traditionally, the min-cut problem identifies the maximum number of link-disjoint paths between certain node pairs, but when the min-cut value of a graph is n, it only confirms the presence of n−1 fully diverse paths connecting one set of nodes (i.e., one “island”) to another, without shedding light on connectivity among nodes within the same island. In 1927, Karl Menger proved that a graph is k-edge-connected (i.e., its min-cut equals k) if and only if every pair of nodes in the graph has k edge-disjoint paths between them (see Böhme, T., Göring, F. and Harant, J. (2001), “Menger's Theorem,” J. Graph Theory, 37:35-36, doi.org/10.1002/jgt.1001, the contents of which are incorporated by reference). Consequently, determining the min-cut of a network is sufficient to guarantee the number of diverse paths between all node pairs. Building on Menger's theorem, we propose a technique tailored to telecommunication networks that accounts for SRLGs when computing the min-cut. This approach not only finds the min-cut but also identifies the critical failure scenarios of minimal size—those specific cuts that the network cannot survive—thereby providing both a measure of survivability and a detailed guide for network enhancements.

The proposed technique builds on the principles of the Stoer-Wagner algorithm (see Mechthild Stoer and Frank Wagner, “A Simple Min-Cut Algorithm,” J. ACM 44, 4 (July 1997), 585-591, doi.org/10.1145/263867.263872, the contents of which are incorporated by reference). The Stoer-Wagner algorithm is a classic polynomial-time approach for finding the global minimum cut in an undirected graph. In its conventional form, the algorithm proceeds by iteratively merging the most “tightly connected” pair of vertices—identified via a repeated maximum adjacency search—and then recording the cut that separates the last merged vertex from the remaining graph. By repeating this process and tracking which merge yields the smallest cut, Stoer-Wagner efficiently arrives at the minimum cut for the graph. However, the standard version of Stoer-Wagner considers individual links in isolation and does not account for higher-level groupings of links prone to failing together.

SRLGs represent a point in the optical network 12—such as fibers routed in the same duct or optical channels sharing common infrastructure—that share a single point of vulnerability. A failure at one point in the optical network 12 simultaneously affects all links belonging to the same SRLG, making it critical to treat them as a single risk group. By extending the Stoer-Wagner algorithm to incorporate SRLGs, the proposed technique is able not only to compute the min-cut in a network but also to identify specific failure scenarios in which multiple links fail concurrently. In doing so, it provides a ranked list of “critical cuts,” giving network engineers actionable insights into the most vulnerable configurations and allowing them to reinforce or redesign those sections of the network 12 accordingly.

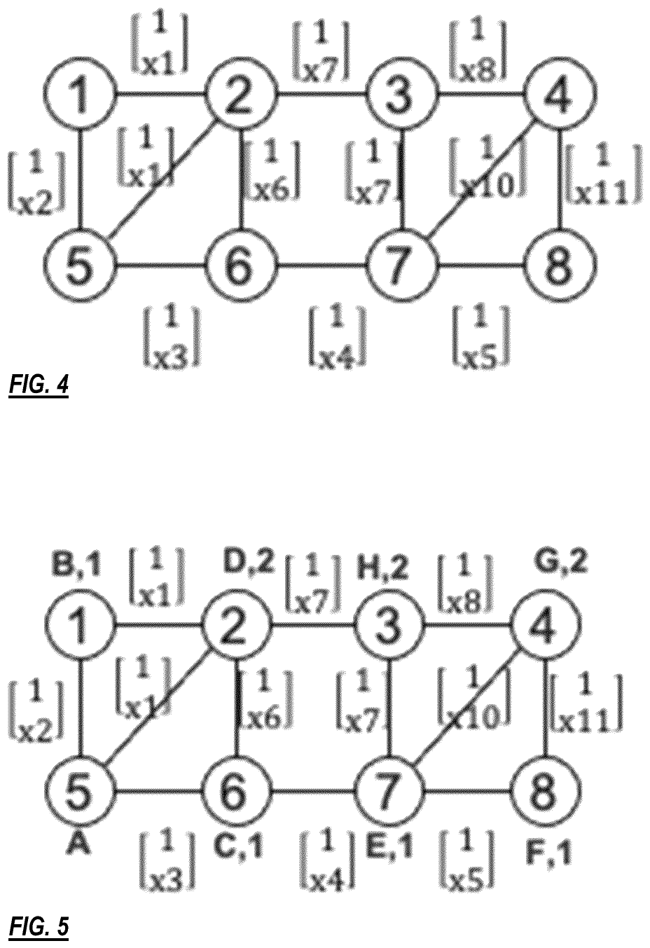

FIGS. 4-12 illustrate, step by step, how the disclosed process identifies min-cut scenarios in an eight-node network. In this example, each node (vertices labeled 1-8) can represent a router 16 in an IP topology 10, and each edge can be a link 18 having one or more SRLGs. Although the figures show only one SRLG per edge (e.g., x1), real-world networks may assign multiple SRLGs to a single link. The following example descriptions with reference to FIGS. 4-12 describe the operating principles of this process. The process works by iteratively merging subsets of vertices in the graph until only two subsets remain. It starts with a single vertex subset and iteratively adds the most tightly connected vertex to the current subset. This process continues until all vertices are included in the two final subsets. In this example, there are steps 0-7 (FIGS. 4-11).

In FIG. 4 (Step 0), the initial network graph is shown with no merges performed, i.e., the graph with the network topology in a graph prior to any operations in the process. Each edge label has the form |1, xS|, where “1” is the weight and “xS” is the SRLG (e.g., x1, x2, etc.).

In FIG. 5 (Step 1), the process starts by selecting a random node, e.g., node 5 labeled “A” and performs a “max adjacency” search to label additional nodes (e.g., node 6 labeled “C,” node 1 labeled “B,” etc.) based on the largest connecting weight to the already-labeled set (LN or labeled nodes). The last two labeled nodes, 3 and 4, are merged into a single vertex for the subsequent iteration.

In this search, we traverse the network to find the node with max weight toward the set of nodes that have already been labeled. The set of labeled nodes (LN) at the beginning is {5}. In the remainder of the graph, we proceed to search for the next node with the largest sum of weights towards the labeled nodes. As seen in step 1, nodes 1 and 6 with weights equal to 1 are labeled after node 5 (LN={5, 6, 1}). Specifically, the node 1 is labeled B and the node 6 is labeled C, i.e., the letter label is sequential in order. Node 2 will be the next node to be labeled, as D. This node 2 has 3 links connected to nodes 1, 5 and 6. However, links “1-2” and “5-2” have the same SRLG (x1), meaning that just two cuts (x1 and x6) is enough to separate node 2 from LN. Hence, node 2 is labeled D and added to LN with weight 2.

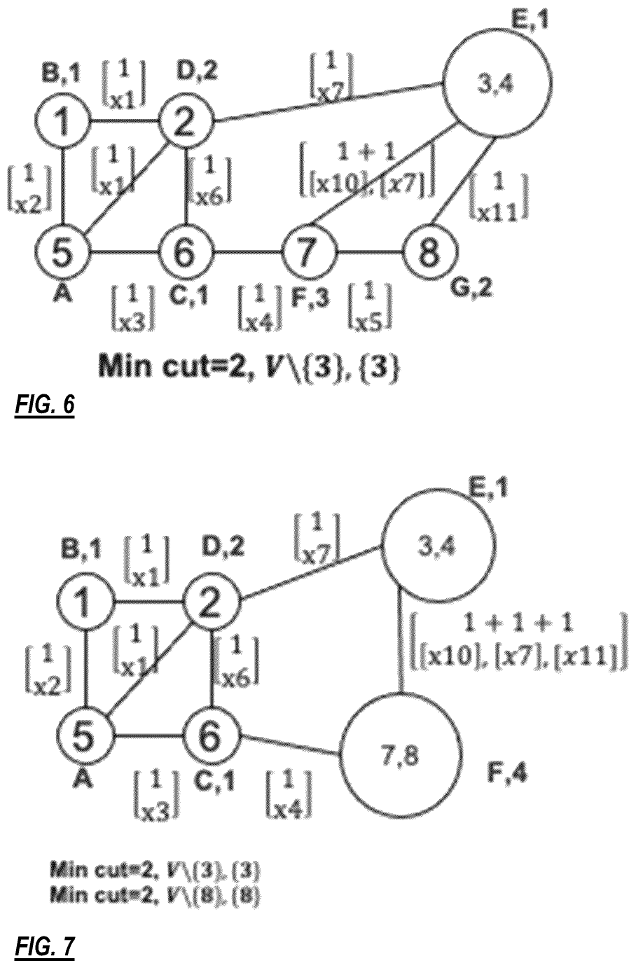

The search goes on until all nodes are labeled in this step 1 in FIG. 5. The weight assigned to the last labeled node shows the current cut. Node 3 is labeled H with weight equal to 2. This means that node 3 can be isolated from the rest of the network under a failure scenario where both SRLGs x7 and x8 are down. Before going to the next step, the last two labeled nodes are merged, and the residual graph is updated. In this example in FIG. 5, the nodes 3 and 4 are merged and the new node gets connected to nodes 2, 7 and 8 (previously connected to either 3 or 4), this is now illustrated in FIG. 6.

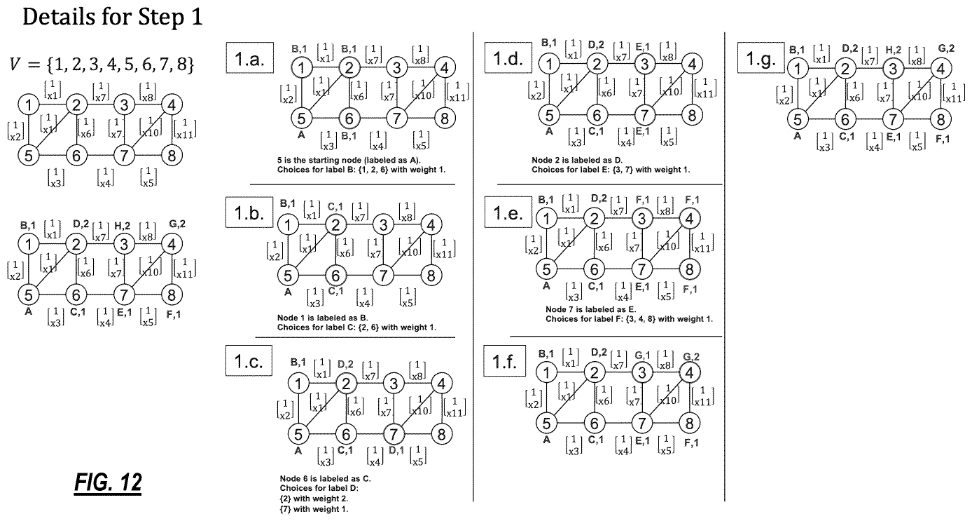

FIG. 12 offers a closer look at the iterative labeling procedure in “Step 1,” broken down into several sub-steps (1.a through 1.g). In sub-step 1.a, the process begins by choosing node 5 and labeling it “A,” making the labeled set LN={5}. Next, as shown in sub-step 1.b, the nodes with the highest sum of link weights connecting them to LN—here, node 1 (weight 1) and node 6 (weight 1)—are labeled in turn, with node 1 labeled “B” and node 6 labeled “C.” In sub-step 1.c, the algorithm evaluates the remaining unlabeled nodes (including nodes 2 and 7) and selects the one with the highest total weight to LN. Since node 2 has a weight of 2 (due to its connections to nodes 1, 5, and 6), it is labeled next (“D”) instead of node 7, which only has weight 1. Sub-step 1.d illustrates that node 7 remains connected to LN through node 6 alone, thereby receiving a weight of 1 and thus being labeled after node 2. Each subsequent sub-step (1.e, 1.f, 1.g) follows the same “max adjacency” logic to label the remaining nodes in descending order of their weights. By the end of these sub-steps, every node has been labeled in sequence, and the final weights assigned to each node show how strongly—or weakly—it is connected to the nodes already in LN. This detailed labeling process underpins the core min-cut determination, as it reveals which SRLGs or link failures could isolate specific nodes (or subsets of nodes) from the rest of the network.

In FIG. 6 (Step 2), after merging nodes 3 and 4, the notation at the bottom—such as “Min cut=2. V\(3), (3)”—indicates that in this iteration, there is a two-edge (two-SRLG) cut that isolates node 3 from the rest of the network. Formally, “V\(3)” denotes the set of all nodes except node 3, and “(3)” denotes node 3 alone. A “min cut=2” means only two edges (each of weight 1) need to fail (i.e., two SRLGs) to disconnect node 3 from V\(3).

In FIG, 7 (Step 3), following another round of labeling and merging on the updated (residual) graph, the process records a new or repeated minimal cut. Whenever “Min cut=2. V\(X), (X)” appears (where X can be a single node or a merged super-node), it signifies that two SRLG failures suffice to isolate X from the rest of the network in this particular partition.

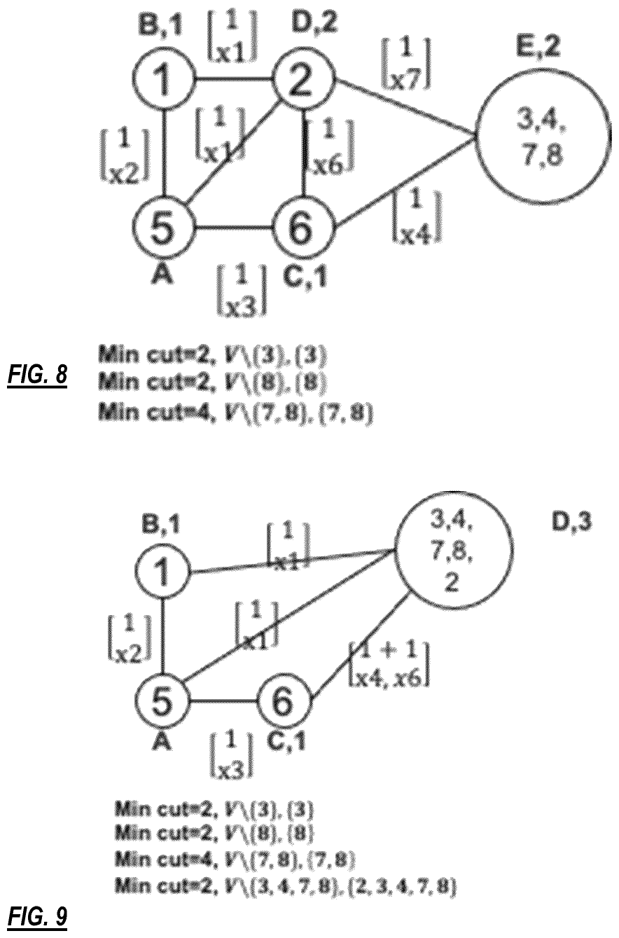

In FIG. 8 (Step 4) and FIG. 9 (Step 5), these figures show further merges and updated min-cut partitions. The process continues to label vertices in descending order of adjacency and then merges the last two labeled vertices. Each time, any notation such as “Min cut=2. V\( . . . ), ( . . . )” or “Min cut=4. V\( . . . ), ( . . . )” pinpoints a critical failure scenario (involving 2 or 4 edges, respectively) that splits the graph into the specified subsets.

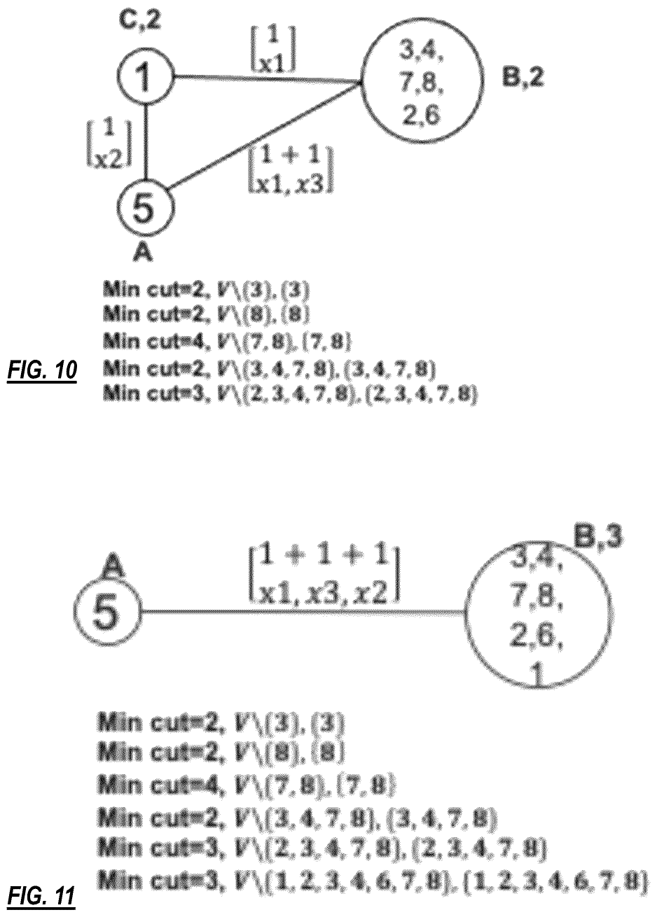

In FIG. 10 (Step 6) and FIG. 11 (Step 7), the process proceeds until only two vertices remain, marking the stopping criterion. By this final stage, all minimal cuts (and thus critical failure scenarios) have been discovered. Notations like “Min cut=2. V\(B), (B)” mean there is a two-edge cut isolating the node or merged set labeled “B.” Ultimately, the smallest min-cut found—2 in this example—indicates the network can be fragmented by certain pairs of SRLG failures (e.g., {x7,x8}), revealing the network's fundamental survivability limit.

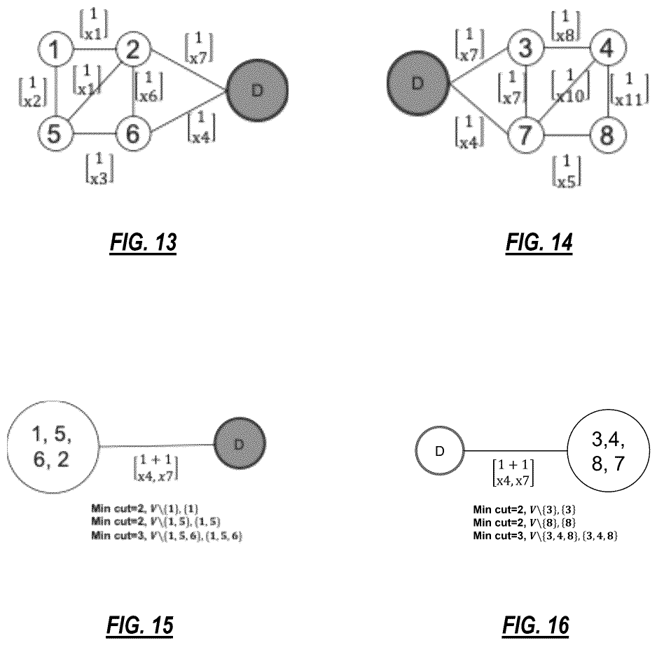

FIGS. 13-16 illustrate how the network graph is split into subgraphs (or “components”) following a critical two-SRLG failure and how additional cuts are discovered within each component. Specifically, FIGS. 13 and 14 (Component 1 and Component 2, respectively) show the immediate result of simultaneously failing SRLGs x4 and x7. As indicated in step 4 of the procedure, this failure divides the original eight-node network into two isolated groups: {1, 2, 5, 6} and {3, 4, 7, 8}. Each of these groups is then replaced with a dummy node (labeled “D”) to allow a fresh run of the max-adjacency/min-cut algorithm on each subgraph.

In FIG. 15 (Cuts in Component 1), the set {1, 2, 5, 6} is analyzed further by treating it as a standalone subgraph with a dummy node D. The algorithm identifies a new two-cut scenario—{x1, x3}—that can isolate the subset {1, 5} from the rest of the subgraph. Similarly, FIG. 16 (Cuts in Component 2) shows that in the other subgraph {3, 4, 7, 8}, different pairs of SRLGs (each labeled with “min cut=2” or “min cut=3”) can disrupt connectivity. By iteratively applying this process and replacing each newly isolated subset with a dummy node, the network engineer compiles a comprehensive list of critical multi-SRLG failures that create isolated “islands.”

The final outcome confirms that every node-pair in this example can survive a single SRLG failure; however, specific two-cut scenarios can fragment the network into separate components. From a design perspective, once these min-cut scenarios have been pinpointed, planners can focus on reinforcing or rerouting critical links to improve survivability, before proceeding to the subsequent stages of network dimensioning.

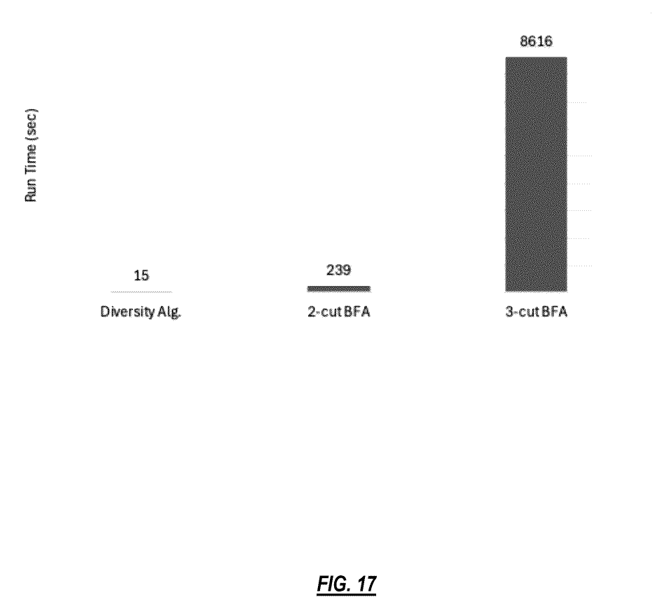

FIG. 17 illustrates a graph of time to perform the process (labeled “diversity alg.”) relative to a traditional bundle failure analysis (BFA) (both 2-cut and 3-cut). This was performed on a small network with 20 nodes (routers), 58 links, and 93 SRLGs. The proposed diversity evaluation process has a much simpler complexity and can drastically reduce the run time compared to the BFA. For a small network with only 20 nodes and 58 links, the process in this proposal takes only 15 seconds while running a 2-cut BFA requires 239 seconds (16 times longer) and a 3-cut BFA requires 8616 seconds (575 times longer).

### Process

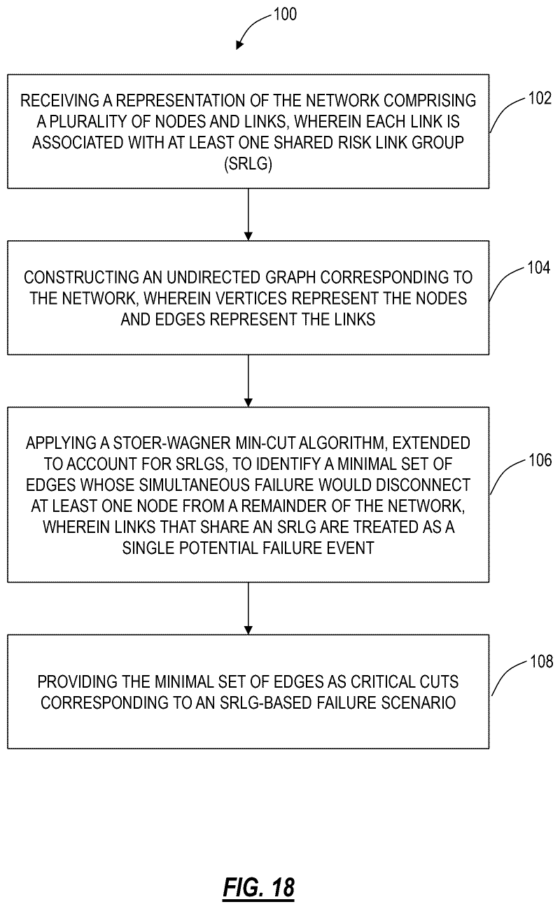

FIG. 18 illustrates a flowchart of a process 100 for assessing survivability in a network. The process 100 can be implemented in various ways, including: as a method including steps, via circuitry configured to execute those steps, and through a non-transitory computer-readable medium that stores instructions which, when executed, cause one or more processors to perform the steps. This flexibility ensures the process 100 can be adapted to different system architectures and deployment scenarios.

The process 100 includes receiving a representation of the network including a plurality of nodes and links, wherein each link is associated with at least one shared risk link group (SRLG) (step 102); constructing an undirected graph corresponding to the network, wherein vertices represent the nodes and edges represent the links (step 104); applying a Stoer-Wagner min-cut algorithm, extended to account for SRLGs, to identify a minimal set of edges whose simultaneous failure would disconnect at least one node from a remainder of the network, wherein links that share an SRLG are treated as a single potential failure event (step 106); and providing the minimal set as critical cuts, each corresponding to an SRLG-based failure scenario, thereby defining a survivability limit of the network (step 108).

The applying the Stoer-Wagner min-cut algorithm includes (i) forming an initial set containing a single vertex; (ii) iteratively adding to the initial set a vertex external to the set that has a highest sum of edge weights connecting it to vertices in the set; (iii) upon labeling all vertices, identifying a pair of vertices in the labeling sequence that define a candidate cut separating one vertex from the rest of the graph; (iv) merging the pair of vertices into a single vertex to produce a residual graph; and (v) repeating steps (iii)-(iv) until only two vertices remain, thereby generating multiple candidate min-cuts for the network. The steps can further include aggregating all edges that share a particular SRLG into a unified failure group prior to executing the min-cut algorithm, such that failure of the SRLG corresponds to failure of all edges in that group.

The extended Stoer-Wagner min-cut algorithm operates in polynomial time with respect to a number of nodes and links in the network, providing a computationally efficient alternative to exhaustive failure simulations. The steps can further include replacing, after identifying a critical minimal cut that splits the network into two or more components, each component with a dummy node, and re-running the extended Stoer-Wagner min-cut algorithm on each resulting residual graph to discover additional SRLG-based cuts within each component. The providing can include a ranked list of critical cuts, each critical cut specifying a set of SRLGs that, if failed concurrently, would isolate a portion of the network from the remainder.

The steps can further include using the critical cuts to guide a network optimization process, including link rerouting or capacity expansion to mitigate identified vulnerabilities. The network is analyzed without relying on a traffic matrix, thereby determining survivability independently of specific traffic demands or flow patterns. The steps can further include detecting an SRLG-based failure in an operational version of the network and comparing the failure to the identified minimal set to determine whether a mitigation or rerouting procedure must be triggered in real time. The method can be used to verify compliance with a predefined survivability requirement, such as guaranteeing no outage under any two SRLG failures.

The steps can further include storing the minimal set (critical cuts) in a database or repository, thereby enabling repeated or incremental survivability analyses without re-running the full algorithm from scratch. The steps can further include presenting the critical cuts via a user interface, wherein each critical cut is displayed alongside corresponding SRLG identifiers and affected network components. The steps can further include updating the weights associated with each edge based on newly discovered risk factors or maintenance records, and re-running the extended Stoer-Wagner min-cut algorithm to obtain revised critical cuts.

The steps can further include applying a threshold to filter out minimal cuts above a predetermined size, thereby focusing on high-impact cuts that require the fewest SRLG failures. A survivability metric can be computed by identifying a smallest integer k for which the network has a min-cut of size k, indicating that concurrent failures of k SRLGs will disconnect at least one subset of the network from the remainder. The steps can further include executing the extended Stoer-Wagner min-cut algorithm multiple times under different weighting functions to produce scenario-specific analyses for evaluating diverse network risk profiles. The steps can further include providing one or more additional minimal sets of edges as critical cuts corresponding to one or more additional SRLG-based failure scenarios.

### Computing Device

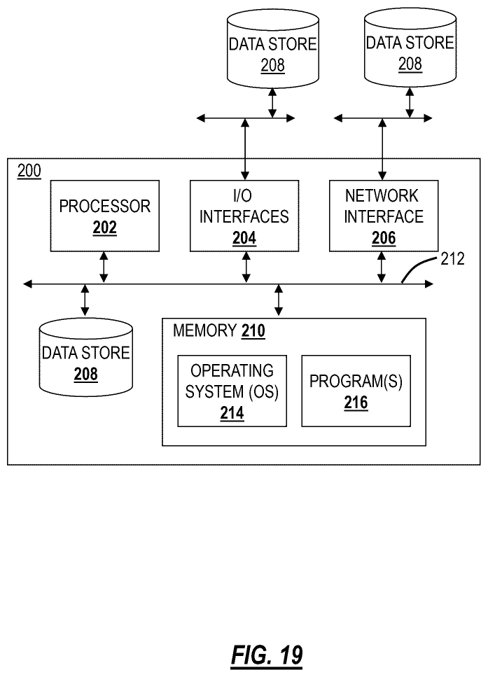

FIG. 19 illustrates a block diagram of a computing device 200 that may be used to implement the process 100. In general, computing device 200 includes a processor 202, input/output (I/O) interfaces 204, a network interface 206, a data store 208, and memory 210. FIG. 19 is simplified for ease of explanation; a practical embodiment may include additional components or processing logic not shown here. These components (202, 204, 206, 208, and 210) communicate via a local interface 212, which can include one or more buses or other wired/wireless connections (along with controllers, caches, drivers, repeaters, and receivers).

The processor 202 is a hardware device for executing software instructions. It may be any custom or commercially available processor—such as a CPU, an auxiliary processor, or a semiconductor-based microprocessor. During operation, processor 202 executes software stored in memory 210, exchanges data with memory 210, and generally controls the computing device 200. The I/O interfaces 204 handle user input and/or provide system output to various external components.

The network interface 206 enables computing device 200 to communicate on a network. It may be an Ethernet or Wireless Local Area Network (WLAN) adapter, or a similar device with address, control, and data connections to support networking. The data store 208 is used to store data and may include any combination of volatile memory (e.g., RAM) or nonvolatile memory (e.g., ROM, hard drives, tapes, CD-ROM), or other storage media.

The data store 208 may be internal to computing device 200 (e.g., an internal hard drive on local interface 212), external (e.g., an external hard drive connected via SCSI or USB), or network-attached (e.g., a network file server). It can incorporate electronic, magnetic, optical, or other types of storage media. The memory 210 may include similar combinations of volatile and/or nonvolatile memory elements (e.g., DRAM, SRAM, SDRAM, ROM, hard drives, tapes, CD-ROM). It may also be distributed across multiple locations but remain accessible to processor 202. The memory 210 stores software that implements logical functions, including an operating system (O/S) 214 and one or more programs 216. The O/S 214 manages scheduling, I/O control, file/data management, memory management, communication control, and related services, while programs 216 implement various processes, algorithms, methods, and techniques described here.

A single computing device 200 or multiple such devices can implement process 100. In some cases, multiple computing devices 200 form a cloud environment that abstracts physical servers, storage, and networking as on-demand, elastic resources. According to the National Institute of Standards and Technology (NIST), cloud computing is a model providing convenient, on-demand network access to a shared pool of configurable computing resources (e.g., servers, storage, applications, and services) that can be rapidly provisioned with minimal management effort or service-provider interaction. Unlike classic client-server systems, cloud computing provides applications from a central server—managed and executed by a client's web browser—requiring no local installation. This centralization allows cloud providers full control over software versions, removing the need for version upgrades or license management on individual client devices. Such applications may be referred to as Software as a Service (SaaS), and the collective resources are often called “the cloud.”

Various embodiments may use different types of processing circuitry, including general-purpose microprocessors, CPUs, digital signal processors (DSPs), specialized processors (e.g., network processors (NPs) or network processing units (NPUs)), graphical processing units (GPUs), field-programmable gate arrays (FPGAs), or programmable logic devices (PLDs). Such circuitry may be controlled by instructions stored in memory (software or firmware) and work with additional circuits to implement some or all functionalities described herein. Alternatively, certain functions can be executed by a state machine without stored program instructions or by one or more application-specific integrated circuits (ASICs) that use dedicated logic or circuit designs. A hybrid of these approaches is also possible. When a hardware device is integrated with software or firmware, it may be described as circuitry or logic “configured to” or “adapted to” perform the methods, processes, and algorithms described herein.

Some embodiments may incorporate a non-transitory computer-readable storage medium storing instructions that program any combination of computer, server, appliance, device, module, processor, or circuit (collectively “system”), each equipped with processing circuitry. When executed, these instructions enable the system to perform the functions described and claimed herein. Such non-transitory media may include, but are not limited to, hard disks, optical disks, magnetic storage devices, ROM, PROM, EPROM, EEPROM, or flash memory. Once stored on these media, the software includes executable instructions that, when executed by one or more processors or programmable circuits, cause those processors or circuits to perform the operations, steps, methods, processes, algorithms, and techniques disclosed herein.

### Conclusion

In this disclosure, including the claims, the phrases “at least one of” or “one or more of” when referring to a list of items mean any combination of those items, including any single item. For example, the expressions “at least one of A, B, or C,” “at least one of A, B, and C,” “one or more of A, B, or C,” and “one or more of A, B, and C” cover the possibilities of: only A, only B, only C, a combination of A and B, A and C, B and C, and the combination of A, B, and C. This can include more or fewer elements than just A, B, and C. Additionally, the terms “comprise,” “comprises,” “comprising,” “include,” “includes,” and “including” are intended to be open-ended and non-limiting. These terms specify essential elements or steps but do not exclude additional elements or steps, even when a claim or series of claims includes more than one of these terms.

Although operations, steps, instructions, blocks, and similar elements (collectively referred to as “steps”) are shown or described in the drawings, descriptions, and claims in a specific order, this does not imply they must be performed in that sequence unless explicitly stated. It also does not imply that all depicted operations are necessary to achieve desirable results. In the drawings, descriptions, and claims, extra steps can occur before, after, simultaneously with, or between any of the illustrated, described, or claimed steps. Multitasking, parallel processing, and other types of concurrent processing are also contemplated. Furthermore, the separation of system components or steps described should not be interpreted as mandatory for all implementations; also, components, steps, elements, etc. can be integrated into a single implementation or distributed across multiple implementations.

While this disclosure has been detailed and illustrated through specific embodiments and examples, it should be understood by those skilled in the art that numerous variations and modifications can perform equivalent functions or achieve comparable results. Such alternative embodiments and variations, even if not explicitly mentioned but that achieve the objectives and adhere to the principles disclosed herein, fall within the spirit and scope of this disclosure. Accordingly, they are envisioned and encompassed by this disclosure and are intended to be protected under the associated claims. In other words, the present disclosure anticipates combinations and permutations of the described elements, operations, steps, methods, processes, algorithms, functions, techniques, modules, circuits, and so on, in any conceivable order or manner—whether collectively, in subsets, or individually—thereby broadening the range of potential embodiments.

What is claimed is:

1. A method for assessing survivability in a network, the method comprising steps of:
receiving a representation of the network comprising a plurality of nodes and links, wherein each link is associated with at least one shared risk link group (SRLG);
constructing an undirected graph corresponding to the network, wherein vertices represent the nodes and edges represent the links;
applying a Stoer-Wagner min-cut algorithm, extended to account for SRLGs, to identify a minimal set of edges whose simultaneous failure would disconnect at least one node from a remainder of the network, wherein links that share an SRLG are treated as a single potential failure event; and
providing the minimal set of edges as critical cuts corresponding to an SRLG-based failure scenario.

2. The method of claim 1, wherein applying the Stoer-Wagner min-cut algorithm includes
(i) forming an initial set containing a single vertex;
(ii) iteratively adding to the initial set a vertex external to the set that has a highest sum of edge weights connecting it to vertices in the set;
(iii) upon labeling all vertices, identifying a pair of vertices in a labeling sequence that define a candidate cut separating one vertex from a rest of the graph;
(iv) merging the pair of vertices into a single vertex to produce a residual graph; and
(v) repeating steps (iii)-(iv) until only two vertices remain, thereby generating multiple candidate min-cuts for the network.

3. The method of claim 2, wherein the steps further include
aggregating all edges that share a particular SRLG into a unified failure group prior to executing the min-cut algorithm, such that failure of the SRLG corresponds to failure of all edges in that group.

4. The method of claim 1, wherein the extended Stoer-Wagner min-cut algorithm operates in polynomial time with respect to a number of nodes and links in the network, providing a computationally efficient alternative to exhaustive failure simulations.

5. The method of claim 1, wherein the steps further include
replacing, after identifying a critical minimal cut that splits the network into two or more components, each component with a dummy node, and re-running the extended Stoer-Wagner min-cut algorithm on each resulting residual graph to discover additional SRLG-based cuts within each component.

6. The method of claim 1, wherein the providing includes a ranked list of critical cuts, each critical cut specifying a set of SRLGs that, if failed concurrently, would isolate a portion of the network from the remainder.

7. The method of claim 1, wherein the steps further include
using the critical cuts to guide a network optimization process, including link rerouting or capacity expansion to mitigate identified vulnerabilities.

8. The method of claim 1, wherein the network is analyzed without relying on a traffic matrix, thereby determining survivability independently of specific traffic demands or flow patterns.

9. The method of claim 1, wherein the steps further include
detecting an SRLG-based failure in an operational version of the network and comparing the failure to the identified minimal set to determine whether a mitigation or rerouting procedure must be triggered in real time.

10. The method of claim 1, wherein the method is used to verify compliance with a predefined survivability requirement, such as guaranteeing no outage under any two SRLG failures.

11. The method of claim 1, wherein the steps further include
storing the minimal set in a database or repository, thereby enabling repeated or incremental survivability analyses without re-running from scratch.

12. The method of claim 1, wherein the steps further include
presenting the critical cuts via a user interface, wherein each critical cut is displayed alongside corresponding SRLG identifiers and affected network components.

13. The method of claim 1, wherein the steps further include
updating weights associated with each edge based on newly discovered risk factors or maintenance records, and re-running the extended Stoer-Wagner min-cut algorithm to obtain revised critical cuts.

14. The method of claim 1, wherein the steps further include
applying a threshold to filter out minimal cuts above a predetermined size, thereby focusing on high-impact cuts that require fewest SRLG failures.

15. The method of claim 1, wherein a survivability metric is computed by identifying a smallest integer k for which the network has a min-cut of size k, indicating that concurrent failures of k SRLGs will disconnect at least one subset of the network from the remainder.

16. The method of claim 1, wherein the steps further include
providing one or more additional minimal sets of edges as critical cuts corresponding to one or more additional SRLG-based failure scenarios.

17. A non-transitory computer-readable medium storing instructions for assessing survivability in a network, the instructions, when executed, cause one or more processors to perform steps of:
receiving a representation of the network comprising a plurality of nodes and links, wherein each link is associated with at least one shared risk link group (SRLG);
constructing an undirected graph corresponding to the network, wherein vertices represent the nodes and edges represent the links;
applying a Stoer-Wagner min-cut algorithm, extended to account for SRLGs, to identify a minimal set of edges whose simultaneous failure would disconnect at least one node from a remainder of the network, wherein links that share an SRLG are treated as a single potential failure event; and
providing the minimal set as critical cuts corresponding to an SRLG-based failure scenario.

18. The non-transitory computer-readable medium of claim 17, wherein applying the Stoer-Wagner min-cut algorithm includes
(i) forming an initial set containing a single vertex;
(ii) iteratively adding to the initial set a vertex external to the set that has a highest sum of edge weights connecting it to vertices in the set;
(iii) upon labeling all vertices, identifying a pair of vertices in a labeling sequence that define a candidate cut separating one vertex from a rest of the graph;
(iv) merging the pair of vertices into a single vertex to produce a residual graph; and
(v) repeating steps (iii)-(iv) until only two vertices remain, thereby generating multiple candidate min-cuts for the network.

19. A system configured for assessing survivability in a network, the system comprising:
one or more processors; and
memory storing instructions that, when executed, cause one or more processors to
receive a representation of the network comprising a plurality of nodes and links, wherein each link is associated with at least one shared risk link group (SRLG),
construct an undirected graph corresponding to the network, wherein vertices represent the nodes and edges represent the links,
apply a Stoer-Wagner min-cut algorithm, extended to account for SRLGs, to identify a minimal set of edges whose simultaneous failure would disconnect at least one node from and a remainder of the network, wherein links that share an SRLG are treated as a single potential failure event, and
provide the minimal set of edges as critical cuts corresponding to an SRLG-based failure scenario.

20. The system of claim 19, wherein applying the Stoer-Wagner min-cut algorithm includes
(i) forming an initial set containing a single vertex;
(ii) iteratively adding to the initial set a vertex external to the set that has a highest sum of edge weights connecting it to vertices in the set;
(iii) upon labeling all vertices, identifying a pair of vertices in a labeling sequence that define a candidate cut separating one vertex from a rest of the graph;
(iv) merging the pair of vertices into a single vertex to produce a residual graph; and
(v) repeating steps (iii)-(iv) until only two vertices remain, thereby generating multiple candidate min-cuts for the network.
